(19) United States
(12) Patent Application Publication
(10) Pub. No.: US 2017/0109775 A1
(43) Pub. Date: Apr. 20, 2017

(54) COUPON MANAGEMENT APPARATUS COUPON MANAGEMENT METHOD, PROGRAM AND RECORDING MEDIUM

(71) Applicant: RAKUTEN, INC., Tokyo (JP)

(72) Inventors: Shigeru ITAHASHI, Tokyo (JP); Satoshi FUJITA, Tokyo (JP)

(73) Assignee: Rakuten, Inc., Tokyo (JP)

(21) Appl. No.: 15/128,599

(22) PCT Filed: Mar. 27, 2014
(86) PCT No.: PCT/JP2014/058805

§ 371 Date: Sep. 23, 2016

(51) Int. Cl. G06Q 30/02

(52) U.S. Cl. CPC G06Q 30/0235; G06Q 30/0239

(57) ABSTRACT

A distribution unit (101) distributes to a customer a coupon for which a valid term is set. Upon receipt of an inquiry about the valid term set for the coupon from the customer to whom the coupon was distributed, an extension unit (102) acquires the valid term set for the coupon from a distributed coupon DB (122). Then, if the acquired valid term has elapsed, the extension unit (102) extends the valid term set for the coupon. In addition, the extension unit (102) determines the period of the extension based on at least a total number or total value of coupons which were distributed to other customers and for which valid terms that have not yet elapsed were set. A reply unit (103) replies to the inquiry with the valid term set for the coupon.

### TECHNICAL FIELD

The present disclosure relates to a coupon management apparatus, coupon management method, program and non-transitory recording medium.

### BACKGROUND ART

At online shopping sites using the Internet, in the past, coupons offering a discount on products have been distributed to users (customers) that use the shopping the shopping site, by shops with a presence on that shopping site and by a manager who manages that shopping site (for example, see Patent Literature 1).

### CITATION LIST

### Patent Literature

Patent Literature 1: Unexamined Japanese Patent Application Kokai Publication No. 2013-77230.

### SUMMARY OF INVENTION

### Technical Problem

In conventional shopping sites, a customer to which a coupon was distributed wants to reliably use the coupon if settlement is prior to the end of coupon's valid term. In addition, if a message, to the effect that a coupon is usable, is shown, at the point in time at which the customer is viewing product pages on the shopping site, the user wants to reliably use the coupon.

In consideration of the foregoing, it is an objective of the present disclosure to provide a coupon management apparatus, coupon management method, program and recording medium that makes a coupon reliably usable to a customer to whom the coupon was presented.

### Solution to Problem

In order to achieve the above-described objectives, a coupon management apparatus according to a first aspect of the present disclosure includes:

a distribution unit for distributing to a customer a coupon for which a valid term has been set;

an extension unit for, upon receipt of an inquiry about the valid term set for the coupon from the customer to whom the coupon was distributed, acquiring the valid term set for the coupon and, if the acquired valid term has elapsed, extending the valid term set for the coupon; and

a reply unit for replying to the inquiry with the valid term set for the coupon;

wherein the extension unit determines the period of the extension based on at least a total number or total value of coupons which were distributed to other customers and for which valid terms that have not yet elapsed were set.

In the coupon management apparatus according to the above aspect, the extension unit determines the period of the extension to be shorter the larger the total number or total value is.

In the coupon management apparatus according to the above aspect, the extension unit resets a coupon-applied discount value or discount percentage at the time of the extension.

In the coupon management apparatus according to the above aspect, the reset discount value or discount percentage is determined based on attributes of the customer.

In the coupon management apparatus according to the above aspect, the extension unit further determines the period of the extension based on the total number or total value of coupons already applied.

In the coupon management apparatus according to the above aspect, the extension unit further determines the period of the extension based on the frequency with which valid terms set for coupons distributed to the customer have been extended in the past.

In the coupon management apparatus according to the above aspect, the distribution unit determines the valid term set for coupon to be distributed based on at least the total number or the total value.

In the coupon management apparatus according to the above aspect, the distribution unit further determines the valid term set for coupon to be distributed based on the total value of discounts from applying the coupons to be distributed and the total number or total value of coupons already applied.

A coupon management method according to a second aspect of the present disclosure is a coupon management method executed by a coupon management apparatus including a distribution unit, an extension unit and a reply unit, the method including:

a distribution step in which the distribution unit distributes to a customer a coupon for which a valid term has been set;

an extension step in which, upon receipt of an inquiry about the valid term set for the coupon from the customer to whom the coupon was distributed, the extension unit acquires the valid term set for the coupon and, if the acquired valid term has elapsed, extends the valid term set for the coupon; and

a reply step in which the reply unit replies to the inquiry with the valid term set for the coupon;

wherein in the extension step, the extension unit determines the period of the extension based on at least a total number or total value of coupons which were distributed to other customers and for which valid terms that have not yet elapsed were set.

A program according to a third aspect of the present disclosure causes a computer to function as:

a distribution unit for distributing to a customer a coupon for which a valid term has been set;

an extension unit for, upon receipt of an inquiry about the valid term set for the coupon from the customer to whom the coupon was distributed, acquiring the valid term set for the coupon and, if the acquired valid term has elapsed, extending the valid term set for the coupon; and

a reply unit for replying to the inquiry with the valid term set for the coupon;

wherein the extension unit determines the period of the extension based on at least a total number or total value of coupons which were distributed to other customers and for which valid terms that have not yet elapsed were set.

A computer-readable non-transitory recording medium according to a fourth aspect of the present disclosure is a computer-readable non-transitory recording medium on which is recorded a program that causes a computer to function as:

a distribution unit for distributing to a customer a coupon for which a valid term has been set;

an extension unit for, upon receipt of an inquiry about the valid term set for the coupon from the customer to whom the coupon was distributed, acquiring the valid term set for the coupon and, if the acquired valid term has elapsed, extending the valid term set for the coupon; and

a reply unit for replying to the inquiry with the valid term set for the coupon;

wherein the extension unit determines the period of the extension based on at least a total number or total value of coupons which were distributed to other customers and for which valid terms that have not yet elapsed were set.

### Advantageous Effects of Invention

With the present disclosure, it is possible for a customer to which a coupon has been presented to reliably use the coupon.

### BRIEF DESCRIPTION OF DRAWINGS

FIG. 1 is a drawing showing the configuration of a coupon management system according to a first exemplary embodiment;

FIG. 2 is a summary block diagram showing the hardware configuration of a coupon management apparatus according to the first exemplary embodiment;

FIG. 3 is a summary block diagram showing the functional configuration of the coupon management apparatus according to the first exemplary embodiment;

FIG. 4 is a drawing showing one example of data stored in a coupon management DB;

FIG. 5 is a drawing showing one example of data stored in a distributed coupon DB according to the first exemplary embodiment;

FIG. 6 is a drawing showing one example of a product page;

FIG. 7 is a drawing showing one example of a product page;

FIG. 8 shows one example of a flowchart for a coupon distribution process according to the first exemplary embodiment;

FIG. 9 shows one example of a flowchart for a valid term reply process according to the first exemplary embodiment;

FIG. 10 shows one example of a flowchart for an extension period determining process according to the first exemplary embodiment;

FIG. 11 is a summary block diagram showing the functional configuration of a coupon management apparatus according to a second exemplary embodiment;

FIG. 12 is a drawing showing one example of data stored in a customer DB according to the second exemplary embodiment;

FIG. 13 is a drawing showing one example of data stored in a distributed coupon DB according to the second exemplary embodiment;

FIG. 14 shows one example of a flowchart for a valid term reply process according to the second exemplary embodiment;

FIG. 15 shows one example of a flowchart for a discount value determining process according to the second exemplary embodiment;

FIG. 16 is a drawing showing one example of data stored in a distributed coupon DB according to a fourth exemplary embodiment;

FIG. 17 shows one example of a flowchart for a coupon distribution process according to a fifth exemplary embodiment;

FIG. 18 shows one example of a flowchart for a valid term determining process according to the fifth exemplary embodiment; and

FIG. 19 shows one example of a flowchart for a valid term determining process according to a sixth exemplary embodiment.

### DESCRIPTION OF EMBODIMENTS

Exemplary embodiments of the present disclosure are described in detail below with reference to the drawings.

### First Exemplary Embodiment

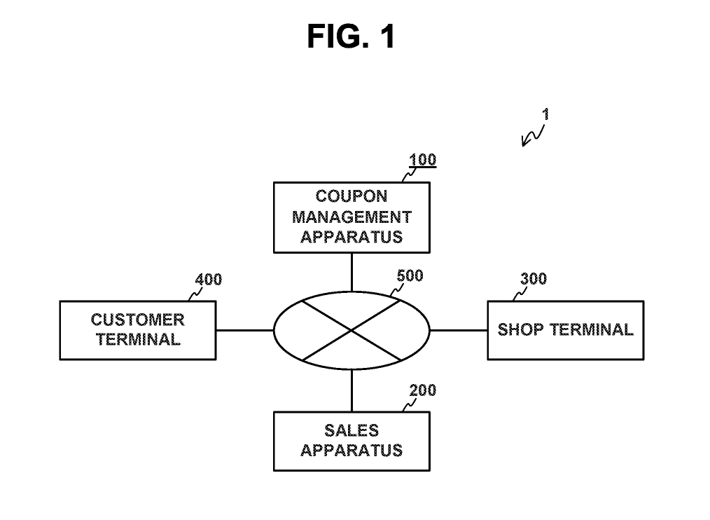

FIG. 1 shows the configuration of a coupon management system 1 according to an exemplary embodiment of the present disclosure. The coupon management system 1 is a system for managing coupons distributed through an online shipping site where products can be bought and sold online.

As shown in FIG. 1, the coupon management system 1 includes a coupon management apparatus 100, a sales apparatus 200, a shop terminal 300 and a customer terminal 400, and the apparatuses are connected so as to be capable of communicating with each other via a network 500 such as the Internet and/or the like.

The coupon management apparatus 100 is a server for managing the coupon management system 1 according to this exemplary embodiment. Specifically, the coupon management apparatus 100, in the online shopping site, manages coupons distributed to users (customers) purchasing products on the shopping site from managers managing the shopping site and users (shops) selling products on the shopping site.

The sales apparatus 200 is a server for managing registration and sales of products on the online shopping site. Specifically, the sales apparatus 200 supplies various Web pages of the online shopping site, registers products to be sold, searches for products being sold, receives product purchases and reservations and executes a product purchase process, in response to requests from the shop terminal 300 and the customer terminal 400.

The shop terminal 300 is a computer operated by a user (shop) selling products on the online shopping site. Specifically, the shop terminal 300 registers information related to products and coupons input by the shop on the sales apparatus 200. In FIG. 1, one shop terminal 300 is displayed, but this is intended to be illustrative and not limiting on the number of shop terminals 300.

The customer terminal 400 is a computer operated by a user (customer) purchasing a product on the online shopping site. Specifically, the customer terminal 400 accesses the sales apparatus 200 and enables browsing, searching, reserving and purchasing of products being sold, in accordance with operational input from the customer. In addition, the customer terminal 400 receives coupons distributed by the coupon management apparatus 100. Furthermore, the customer terminal 400 receives information related to the distributed coupons, from the coupon management apparatus 100. In FIG. 1, one customer terminal 400 is shown, but this is intended to be illustrative and not limiting on the number of customer terminals 400.

Next, the configuration of the coupon management apparatus 100 is described in detail.

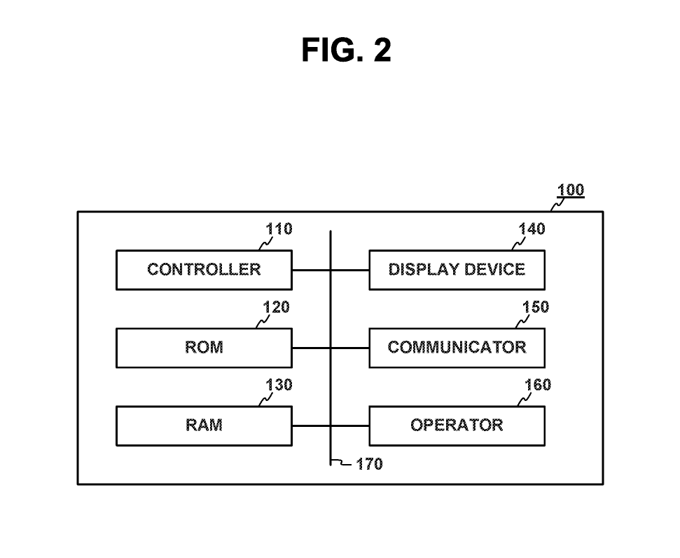

FIG. 2 is a summary block diagram showing the hardware configuration of the coupon management apparatus 100. As shown in FIG. 2, the coupon management apparatus 100 includes a controller 110, ROM (Read Only Memory) 120, RAM (Random Access Memory) 130, display device 140, communicator 150 and operator 160, and the various components are connected by a bus 170.

The controller 110 includes for example, a CPU (Central Processing Unit) and accomplishes control of the entirety of the coupon management apparatus 100.

The ROM 120 is non-volatile memory in which the controller 110 stores various kinds of data and programs to control the entirety of the coupon management apparatus 100.

The RAM 130 is volatile memory for temporarily storing information generated by the controller 110 and data necessary for generating this information.

The display device 140 includes a display device equipped with an LCD (Liquid Crystal Display), a backlight and/or the like. The display device 140 displays data output from the controller 110, for example, under control of the controller 110.

The communicator 150 includes a communication interface for connecting the coupon management apparatus 100 to the network 500.

The operator 160 includes an input device such as a button, touch panel, keyboard and/or the like. The operator 160 receives operation input from the user and outputs to the controller 110 an operation input signal corresponding to the operation input received.

Next, the functional configuration of the coupon management apparatus 100 is described.

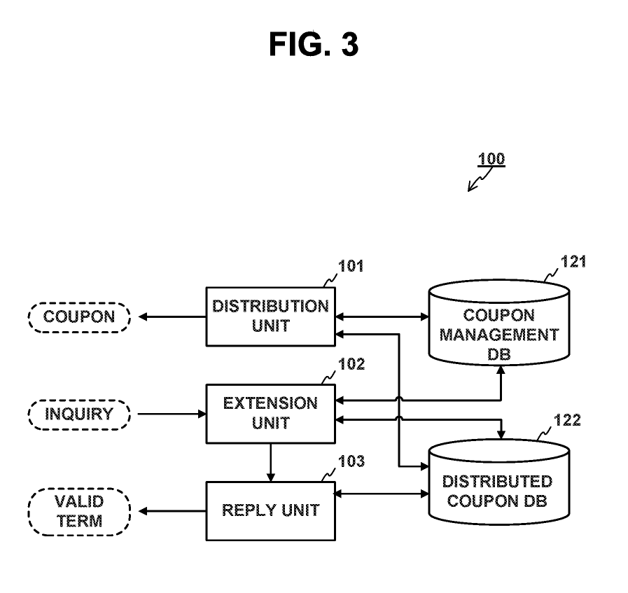

FIG. 3 is a summary block diagram showing the functional configuration of the coupon management apparatus 100. As shown in FIG. 3, the coupon management apparatus 100 includes a distribution unit 101, an extension unit 102 and a reply unit 103.

The distribution unit 101 distributes to customers coupons for which valid terms have been set.

Specifically, the distribution unit 101, upon receiving an instruction ordering distribution of coupons, references a coupon management DB (database) 121 and distributes the coupons to customers satisfying distribution conditions for those coupons.

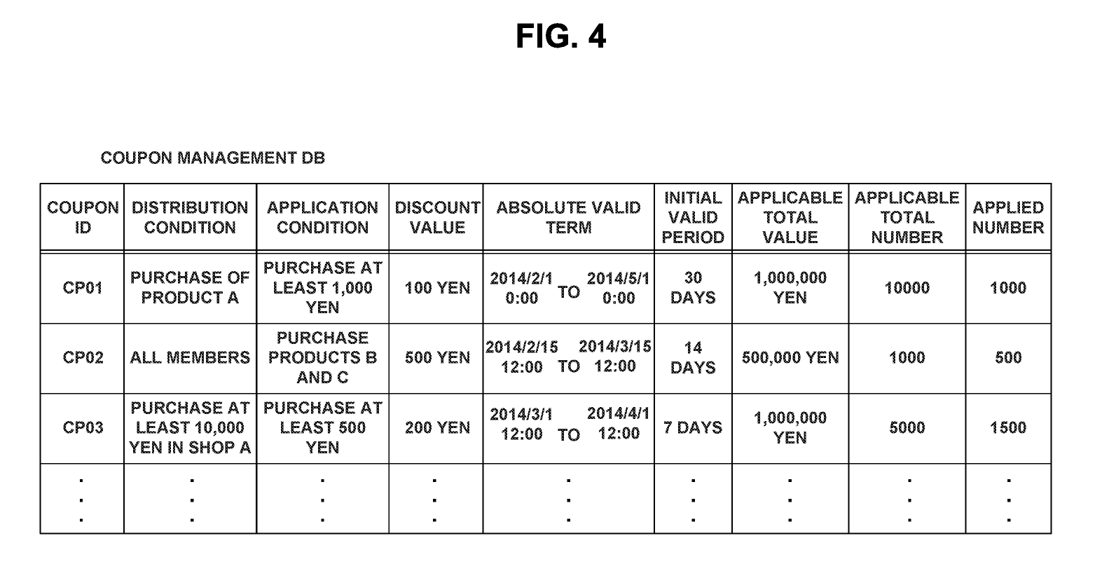

FIG. 4 shows one example of data stored in the coupon management DB 121. The coupon management DB 121 shown in FIG. 4 stores, for each coupon, a coupon ID, distribution condition, application condition, discount value, absolute valid term, initial valid period, applicable total value, applicable total number and applied number. The coupon ID is information identifying the coupon. The distribution condition indicates a condition for distributing the coupon, so that the coupon is distributed to a customer satisfying the distribution condition. The application condition indicates a condition under which a coupon can be applied, and if a customer satisfies the application condition, the customer is permitted to use the coupon. The discount value indicates the amount of discount when the coupon is applied. The absolute valid term is a term during which the coupon is usable, as determined by the shop or the manager of the online shopping site issuing the coupon. The initial valid period is a valid period set for the coupon when the coupon is distributed. That is to say, when the coupon is distributed, the valid term set for that coupon is from when the coupon was distributed until the valid period elapses. The applicable total value is the total of the discount values in the event that all coupons are applied. The applicable total number is the total number of coupons that can be applied. The applied number is the total number of coupons that were applied by the current point in time. The coupon ID, distribution conditions, application conditions, discount value, absolute valid term, initial valid period, applicable total value and applicable total number are input by the shop or the manager of the online shopping site issuing the coupon, and are stored in the coupon management DB 121. In addition, the applied number is updated each time a coupon is applied.

For example, the distribution unit 101, upon receiving an order to distribute coupons from a shop or a manager of the online shopping site issuing the coupons, references the coupon management DB 121 and sets as the valid term of that coupon the period from the start date and time of the absolute valid term of that coupon or, when the start date and time of the absolute valid term has elapsed at the current point in time, from the current date and time until the initial valid period has elapsed. Furthermore, the distribution unit 101 distributes coupons for which the valid term is set to customers satisfying the distribution condition of that coupon, with the applicable total number as the upper limit. The coupon management DB 121 may be recorded in the ROM 120 or may be recorded in an external memory device.

In addition, the distribution unit 101, upon distributing the coupon, records in the distributed coupon DB 122 the distributed coupon, the customer to whom the coupon was distributed and the valid term set for that coupon, associating these together.

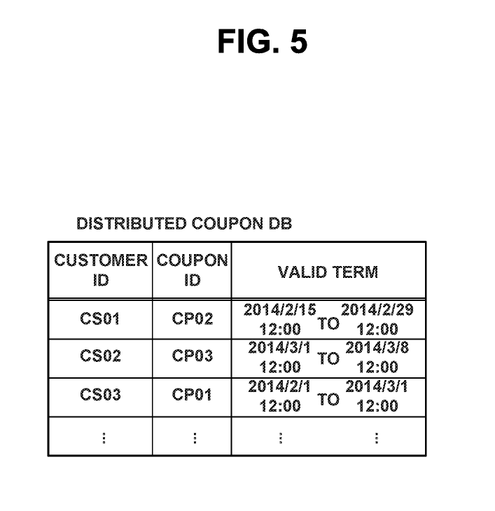

FIG. 5 shows one example of data stored in the distributed coupon DB 122. The distributed coupon DB 122 shown in FIG. 5 for each customer stores a customer ID, a coupon ID and a valid term. The customer ID is information identifying the customer. For example, when a coupon for which the valid term is set as “2014/2/1 12:00 to 2014/3/1 12:00” and having a coupon ID of “CP01” is distributed to a customer having a customer ID of “CS03”, the distribution unit 101 records that valid term and coupon ID in the distributed coupon DB 122, associated with the customer ID. In addition, when the coupon is used by the customer, that customer ID, the coupon ID and the valid term are deleted from the distributed coupon DB 122. The distributed coupon DB 122 may be recorded in the ROM 120 or may be recorded in an external memory device.

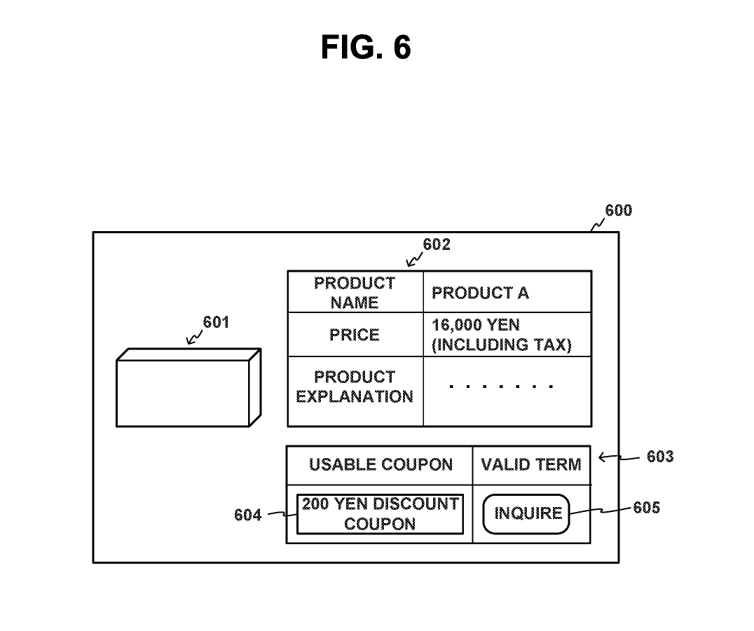

In addition, the method of distributing coupons by the distribution unit 101 is such that coupons are distributed to customers by presenting information relating to the coupon on a mail or a Web page. FIG. 6 shows an example of presenting to the customer a coupon distributed by the distribution unit 101. FIG. 6 illustrates an example in which a coupon is presented on a product page 600 of an online shopping site displayed on the customer terminal 400. The product page 600 shown in FIG. 6 includes a product image 601, product information 602 and coupon information 603. The product information 602 includes a product name, price and explanation of the product. In addition, the coupon information 603 includes coupons usable by the customer to which the product page 600 is presented, and the valid terms. In FIG. 6, a usable coupon is presented as a coupon image 604. In addition, in FIG. 6, in place of a valid term, an inquiry button 605 is presented for making inquiries about the valid term set for the coupon to the coupon management apparatus 100 without presenting such to the customer. When the inquiry button 605 is selected by the customer, the customer terminal 400 outputs information indicating that the inquiry button 605 was selected by the customer, to the coupon management apparatus 100.

In this exemplary embodiment, the controller 110 and the communicator 150 work together to function as the distribution unit 101.

When an inquiry about the valid term set for that coupon is made from the customer to whom the coupon was distributed, the extension unit 102 acquires the valid term set for that coupon and if the valid term acquired has elapsed, extends the valid term set for that coupon.

For example, upon receiving an input from the customer terminal 400 to the effect that the inquiry button 605 of the product page 600 shown in FIG. 6 has been selected by the customer, the extension unit 102 determines that there was an inquiry about the valid term set for the coupon from the customer.

Furthermore, when it is determined that there was an inquiry about the valid term set for the coupon from the customer, the extension unit 102 references the distributed coupon DB 122 and acquires the valid term corresponding to the customer and the coupon. Furthermore, the extension unit 102 determines whether or not the acquired valid term has elapsed by the current date and time. When it is determined that the acquired valid term has elapsed by the current date and time, that is to say when it is determined that the valid term has elapsed, the extension unit 102 sets an extension period based on the total number of coupons distributed to other customers and for which the valid terms that were set have not yet elapsed. Furthermore, the extension unit 102 updates the valid term of the coupon stored in the distributed coupon DB 122 so that the valid term is extended by the set extension period.

Below, one example of determining the extension period with the extension unit 102 is described. In the explanation below, the extension unit 102 determines the period of the extension to be shorter the larger the total number of coupons with set valid terms that have not yet elapsed that were distributed to other customers (distributed effective number) is.

For example, when the distributed effective number N is less than a first extension period threshold value N1 (for example, 100), the extension unit 102 determines the extension period as D1 (for example, one month). In addition, when the distributed effective number N is at least as great as N1 but less than a second extension period threshold value N2 (where N2>N1; for example 500), the extension unit 102 determines the extension period as D2 (where D2<D1; for example, one week). In addition, when the distributed effective number is at least as great as N2, the extension unit 102 determines the extension period as D3 (where D3<D2; for example 1 day). The values N1, N2 and D1 to D3 may be preset by the shop or the manager of online shopping site, or may be set in accordance with the applicable total number of coupons or absolute valid term. In addition, in the above-described example, the extension period was set based on two threshold values N1 and N2, but the number of threshold values is not limited to this.

In the exemplary embodiment, the controller 110 and the communicator 150 function as the extension unit 102.

The reply unit 103 replies with the valid term set for a coupon, in response to an inquiry.

Specifically, the reply unit 103 references the distributed coupon DB 122 and acquires the valid term corresponding to the coupon and the customer that made the inquiry. Then, the reply unit 103 transmits the acquired valid term to the customer terminal 400 that output the inquiry.

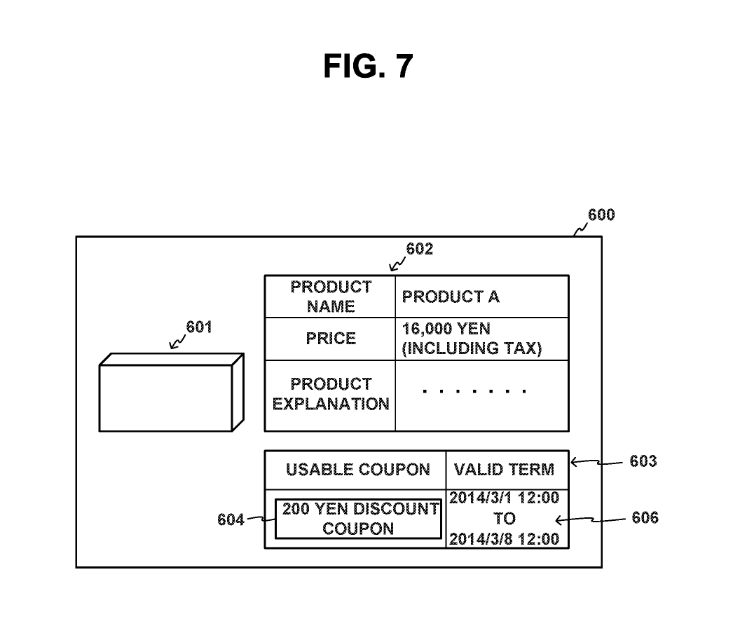

FIG. 7 shows the product page 600 when the inquiry button 605 shown in FIG. 6 was selected and the reply unit 103 replied with a valid term. In the product page 600 shown in FIG. 7, a valid term 606 that was the reply from the reply unit 103 is presented.

In this exemplary embodiment, the controller 110 and the communicator 150 work together to function as the reply unit 103.

Next, operation of the coupon management apparatus 100 according to the first exemplary embodiment is described.

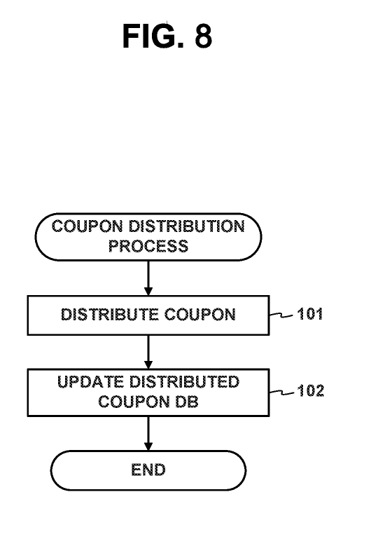

A coupon distribution process executed by the coupon management apparatus 100 according to the first exemplary embodiment is described below. FIG. 8 shows one example of a flowchart for the coupon distribution process according to the first exemplary embodiment. The coupon distribution process shown in FIG. 8 starts, for example, with receipt of input ordering that coupons be distributed, from a shop or a manager of the online shopping site via the communicator 150 or the operator 160. This process is executed for example by the CPU of the controller 110 reading a program stored in the ROM 120.

First, the distribution unit 101 distributes a coupon to a customer (step S101).

For example, upon receiving input ordering distribution of a coupon with coupon ID “CP03” from the manager of the online shopping site via the operator 160, the distribution unit 101 references the coupon management DB 121 and acquires a start date and time of “2014/3/1 12:00” of the absolute valid term corresponding to the coupon ID “CP03”. Then, when it is determined that the current date and time have not elapsed the start date and time of “2014/3/1 12:00” of the absolute valid term, the distribution unit 101 sets the valid term as “2014/3/1 12:00 to 2014/3/8 12:00” based on the start time “2014/3/1 12:00” of the absolute valid term and the initial valid period “7 days”. Then, the distribution unit 101 distributes the coupon with coupon ID “CP03” to customers satisfying the distribution condition “purchased more than 10,000 yen at shop A”, with the applicable total number “5,000” as the upper limit.

Then, the distribution unit 101 updates the distributed coupon DB 122 regarding the distributed coupon (step S102).

For example, when a coupon with coupon ID “CP03” with a valid term of “2014/3/1 12:00 to 2014/3/8 12:00” as the determined valid term is distributed to customer ID “CS02” in step S101, the distribution unit 101 stores the customer ID “CS02”, the coupon ID “CP03” and the valid term of “2014/3/1 12:00 to 2014/3/8 12:00” in the distributed coupon DB 122, associated with each other, as shown in FIG. 5.

Then, the coupon management apparatus 100 ends the coupon distribution process.

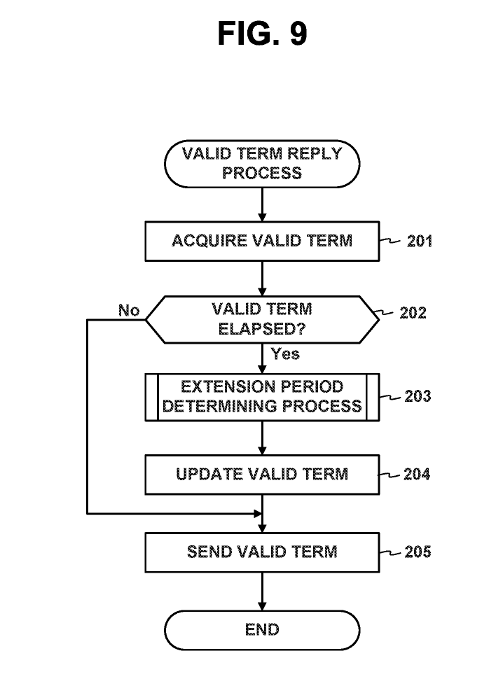

Next, the valid term reply process executed by the coupon management apparatus 100 is described. FIG. 9 shows one example of a flowchart of the valid term reply process. The valid term reply process shown in FIG. 9 starts when for example an inquiry about the valid term is received from the customer terminal 400. This process is executed for example by the CPU of the controller 110 reading a program stored in the ROM 120.

The extension unit 102 references the distributed coupon DB 122 and acquires the valid term of the coupon inquired about (step S201).

For example, when an inquiry about the valid term of a coupon having a coupon ID of “CP03” is received from a customer with a customer ID of “CS02”, the extension unit 102 references the distributed coupon DB 122 and acquires the valid term “2014/3/1 12:00 to 2014/3/8 12:00” corresponding to the customer ID “CS02” and the coupon ID “CP03”.

Next, the extension unit 102 determines whether or not the valid term acquired in step S201 has elapsed (step S202). When it is determined that the valid term acquired in step S201 has not elapsed (step S202: No), the extension unit 102 advances the process to step S205.

Specifically, the extension unit 102 compares the valid term acquired in step S201 with the current date and time. Then, when the current date and time is later than the final date and time of the valid term, the extension unit 102 determines that the acquired valid term has elapsed. Conversely, when the current date and time is prior to the final date and time of the valid term, the extension unit 102 determines that the acquired valid term has not elapsed.

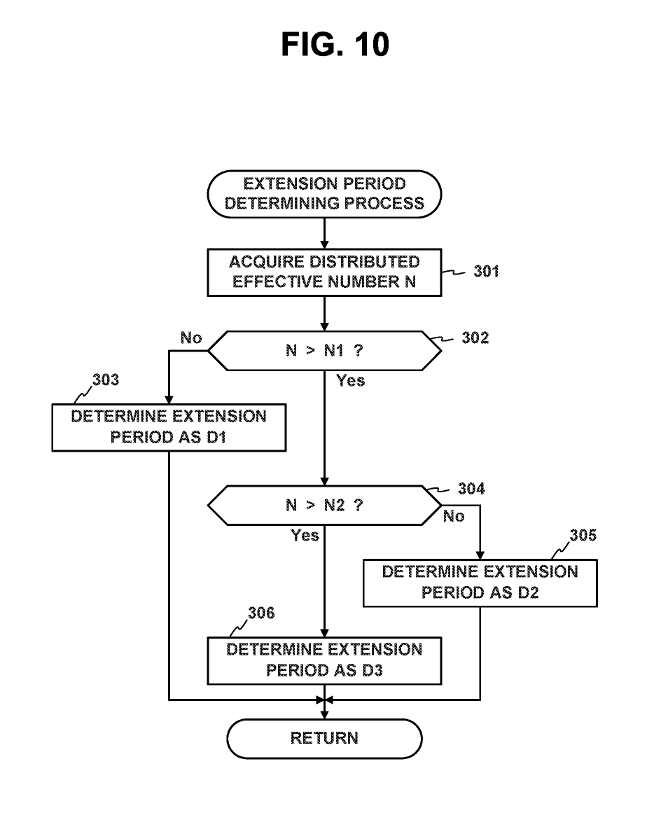

When it is determined that the valid term acquired in step S201 has elapsed (step S202: Yes), the extension unit 102 executes an extension period determining process shown in FIG. 10 (step S203).

FIG. 10 shows one example of a flowchart of the extension period determining process. As shown in FIG. 10, when the extension period determining process begins, the extension unit 102 acquires the distributed effective number N of the coupon about which an inquiry regarding the valid term was made (step S301).

For example, when an inquiry was made about the valid term of the coupon with coupon ID “CP03” from the customer with customer ID “CS02”, the extension unit 102 references the distributed coupon DB 122 and acquires the number of coupons for which the valid term has not elapsed, out of the coupons having coupon ID “CP03” distributed to customers other than the customer with the customer ID “CS02”, as the distributed effective number N.

Next, the extension unit 102 determines whether or not the distributed effective number N acquired in step S301 is larger than a first extension period threshold value N1 (step S302).

When it is determined that the distributed effective number N is not larger than N1 (step S302: No), the extension unit 102 determines the extension period as D1 (step S303). Then, the process advances to step S204 in FIG. 9.

When it is determined that the distributed effective number N is larger than N1 (step S302: Yes), the extension unit 102 determines whether or not the distributed effective number N is larger than a second extension period threshold value N2 (step S304).

When it is determined that the distributed effective number N is not larger than N2 (step S304: No), the extension unit 102 determines the extension period as D2 (step S305). Then, the process advances to step S204 in FIG. 9.

When it is determined that the distributed effective number N is larger than N2 (step S304: Yes), the extension unit 102 determines the extension period as D3 (step S306). Then, the process advances to step S204 in FIG. 9.

Furthermore, returning to the flowchart in FIG. 9, the extension unit 102 references the distributed coupon DB 122 and updates the valid term of the coupon about which an inquiry was made to extend the period by the extension period determined in the extension period determining process of step S203 from the current date and time (step S204).

For example, when an inquiry about the valid term of a coupon with coupon ID “CP03” is received from the customer with customer ID “CS02” and the current date and time of “3014/3/9 0:00” is after the valid term of “2014/3/1 12:00 to 2014/3/8 12:00” corresponding to the customer ID “CS02” and the coupon ID “CP03”, assuming that the extension unit 102 determines an extension period of one week in step S203, the extension unit references the distributed coupon DB 122 and updates the valid term “2014/3/1 12:00 to 2014/3/8 12:00” corresponding to the customer ID “CS02” and the coupon ID “CP03” to “2014/3/9 0:00 to 2014/3/16 0:00”, ending one week from the current date and time “2014/03/09 0:00”.

Next, the reply unit 103 references the distributed coupon DB 122, acquires the valid term of the coupon of the customer from which the inquiry was received, and transmits the acquired valid term to the customer (step S205).

Then, the coupon management apparatus 100 ends the valid term reply process.

As explained above, upon receipt of an inquiry about the valid term of a coupon from a customer to which the coupon was distributed, the coupon management apparatus 100 according to this exemplary embodiment extends the valid term if the valid term of the coupon has elapsed. Accordingly, the customer to whom the coupon was distributed can reliably use the coupon presented. In addition, even if the valid term of the coupon has elapsed, it is possible to promote use of the coupon by making the valid term extendable.

In addition, the coupon management apparatus 100 sets the extension period shorter the larger the total number of already distributed coupons that are within the valid term is. Accordingly, it is possible to promote swift coupon use by the customer.

### Second Exemplary Embodiment

In the above-described first exemplary embodiment, the extension unit 102 determines the extension period based on the total number of coupons which have been distributed and for which the valid term has not elapsed. At this time, it would be fine for the extension unit 102 to also reset the discount value resulting from applying the coupon. In a second exemplary embodiment, an example is described in which the extension unit 102 resets the discount value at the time of extension.

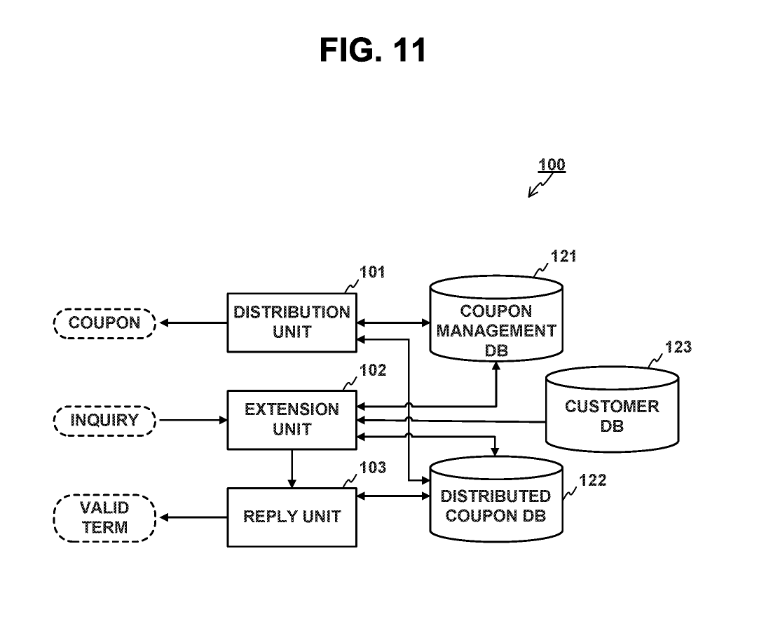

FIG. 11 is a summary block diagram showing the function configuration of a coupon management apparatus 100 according to the second exemplary embodiment. In the second exemplary embodiment, the extension unit 102, at the time of making an extension, references a customer DB 123 and sets the discount value on the basis of the attributes of the customer that made the inquiry.

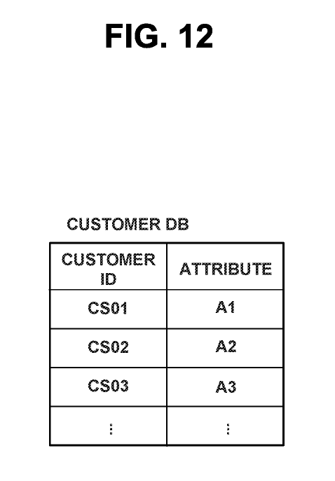

FIG. 12 shows one example of data stored in the customer DB 123. In the customer DB 123 shown in FIG. 12, for each customer a customer ID and an attribute of that customer are associated with each other and stored. An attribute of a customer is bestowed for example based on the value of transactions or usage frequency on the online shopping site. For example, one of attributes “A3”, “A2”, “A1” is bestowed on the customer in ascending order of usage frequency of the online shopping site. The customer DB 123 may be stored in the ROM 120 or may be stored in an external memory device.

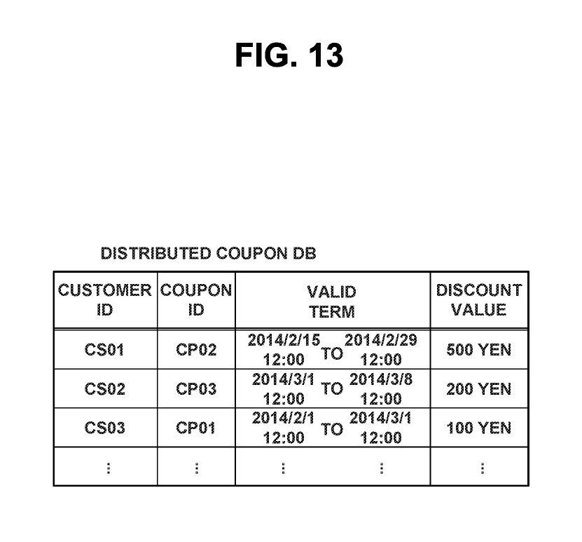

The extension unit 102 determines the discount value based on the attribute of the user acquired from the customer DB 123 at the time of extension. For example, when the attribute of the customer indicates the customer's usage frequency, the extension unit 120 determines the discount value so as to be lower the higher the customer's usage frequency is. For example, suppose the attributes “A1”, “A2”, “A3” are respectively associated with a discount value difference of ΔP1 (for example, −10 yen), ΔP2 (where ΔP2>ΔP1; for example, 10 yen), ΔP3 (where ΔP3>ΔP2; for example 30 yen). Then, the extension unit 102, at the time of extension, determines a new discount value as a value found by adding the discount value difference corresponding to the customer's attribute to the current discount value. Then, the extension unit 102 stores the new discount value in the distributed coupon DB 122 shown in FIG. 13, associating such with the coupon ID and the customer ID of the customer who made the inquiry.

FIG. 13 shows one example of data stored in the distributed coupon DB 122 according to the second exemplary embodiment. In comparison to the distributed coupon DB 122 according to the first exemplary embodiment shown in FIG. 5, the distributed coupon DB 122 according to the second exemplary embodiment shown in FIG. 13 further stores a discount value for each customer.

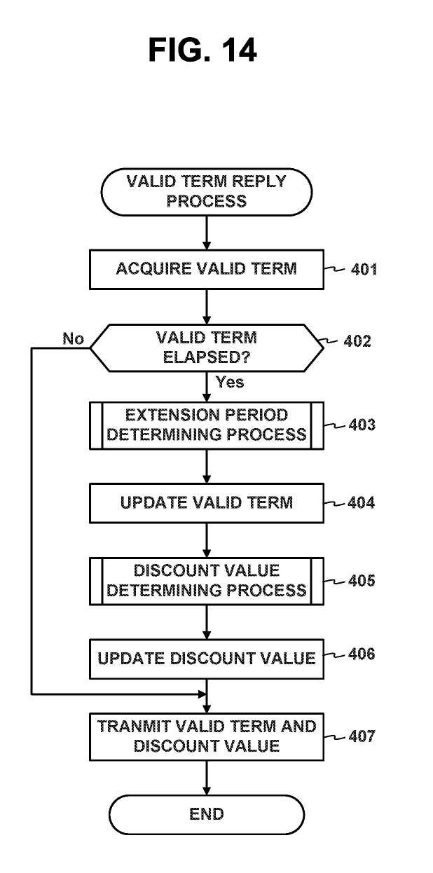

Next, a valid term reply process executed by the coupon management apparatus 100 according to the second exemplary embodiment is described. FIG. 14 shows one example of a flowchart of the valid term reply process according to the second exemplary embodiment. The valid term reply process shown in FIG. 14 is, for example, started when an inquiry about the valid term is received from the customer terminal 400. This process is executed by the CPU of the controller 110 reading a program stored in the ROM 120, for example.

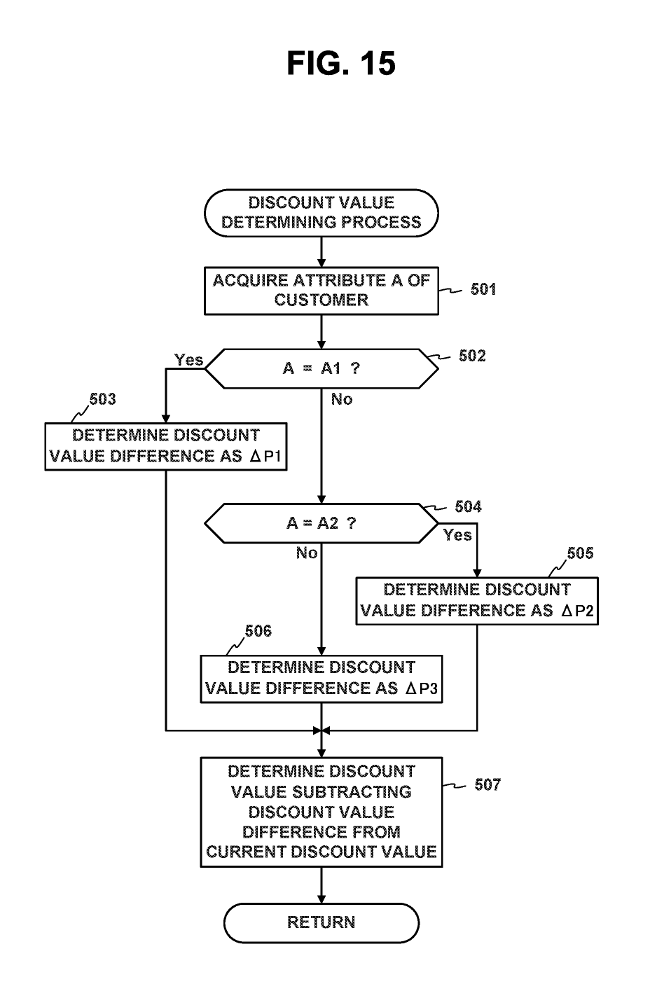

First, the coupon management apparatus 100, in steps S401-S404, executes the process the same as in steps S201-S204 of the valid term reply process according to the first exemplary embodiment shown in FIG. 9. Then, the coupon management apparatus 100 executes a discount value determining process shown in FIG. 15 (step S405).

FIG. 15 shows one example of a flowchart of the discount value determining process. As shown in FIG. 15, when the discount value determining process is started, the extension unit 102 references the customer DB 123 and acquires an attribute A of the customer that made the inquiry about the valid term (step S501).

Next, the extension unit 102 determines whether or not the attribute A acquired in step S501 is the attribute “A1” (step S502).

When it is determined that the attribute A is the attribute “A1” (step S502: Yes), the extension unit 102 determines the discount value difference as ΔP1 (step S503). Then, the process advances to step S507.

When it is determined that the attribute A is not the attribute “A1” (step S502: No), the extension unit 102 determines whether or not the attribute A is the attribute “A2” (step S504).

When it is determined that the attribute A is the attribute “A2” (step S504: Yes), the extension unit 102 determines the discount value difference as ΔP2 (step S505). Then, the process advances to step S507.

When it is determined that the attribute A is not the attribute “A2”, that is to say when it is determined that the attribute A is the attribute “A3” (step S504: No), the extension unit 102 determines the discount value difference as ΔP3 (step S506).

Next, the extension unit 102 determines a new discount value by adding the determined discount value difference to the discount value stored in the distributed coupon DB 122 (step S507).

For example, when an inquiry is received about the valid term of the coupon with coupon ID “CP03” from the customer with customer ID “CS02”, the extension unit 102 references the customer DB 123 and acquires the attribute “A2” corresponding to the customer ID “CS02”. Then, the extension unit 102 determines the discount value difference as ΔP2 (for example, 10 yen), based on the attribute “A2”. Then, the extension unit 102 references the distributed coupon DB 122 shown in FIG. 13, and determines the new discount value as“210 yen”, found by adding 10 yen that is the value of ΔP2 to the “200 yen” current discount value corresponding to the customer ID “CS02” and the coupon ID “CP03”.

Then, returning to the flowchart in FIG. 14, the extension unit 102 references the distributed coupon DB 122 and updates the discount value of the coupon for which inquiry was made from the current discount value to the discount value determined in the discount value determining process of step S405 (step S406).

Next, the reply unit 103 references the distributed coupon DB 122, acquires the discount value and valid term of the coupon of the customer from which the inquiry was received, and transmits the acquired discount value and valid term to the customer (step S407).

Then, the coupon management apparatus 100 ends the valid term reply process.

As described above, in the coupon management apparatus 100 according to the second exemplary embodiment, by determining the discount value based on customer attributes, it is possible to apply a difference in ease of purchasing for each customer. In addition, it is possible to stoke buying interest in customers with low usage frequency, by making the discount value for each extension larger the lower the customer's usage frequency is.

### Third Exemplary Embodiment

In the above-described first exemplary embodiment, the extension unit 102 determines the extension period based on the total number of coupons with valid terms which have been distributed to other customers and for which the valid terms have not yet elapsed. However, the factor for determining the extension period is not limited to this. In this third exemplary embodiment, an example of determining the extension period based on the total number of coupons that have already been applied is further explained.

In the third exemplary embodiment, the extension unit 102 determines the extension period based on the distributed effective number and the total number of coupons already applied (applied number). Specifically, the extension unit 102 determines the extension period to be shorter the larger the applied number is. That is to say, the extension unit 102 determines the extension period with the distributed effective number and the applied number as parameters.

In the extension period determining process of the first exemplary embodiment shown in FIG. 10, the extension unit 102 determines the extension period by comparing the distributed effective number N to threshold values N1 and N2. In place of this, the extension unit 102 according to the third exemplary embodiment sets the extension period by comparing the sum of the distributed effective number N and the applied number to threshold values, for example, in the extension period determining process.

As described above, the coupon management apparatus 100 according to the third exemplary embodiment determines the extension period based on the total number of coupons already applied in addition to the total number of coupons which were distributed to other customers and for which valid terms that have not yet elapsed were set. Through this, it is possible to cause the number of coupons that were applied to be reflected in the extension period. In addition, it is possible to stoke buying interest in customers by making the extension period shorter the larger the number of coupons that have been applied is.

### Fourth Exemplary Embodiment

In a fourth exemplary embodiment, as a different example of a method of determining the extension period by the extension unit 102, an example is described in which the extension period is determined based on the number of times the valid terms set on coupons distributed to the customer have been extended in the past, in addition to the total number of coupons which were distributed to other customers and for which a valid term that has not yet elapsed was set.

In the fourth exemplary embodiment, the extension unit 102 determines the extension period based on the distributed effective number and the number of times the extensions have been made in the past for the customer who made the inquiry (extension frequency). Specifically, the larger the extension frequency is, the shorter the extension unit 102 determines the extension period. That is to say, the extension unit determines the extension period through the two parameters of distributed effective number and extension frequency.

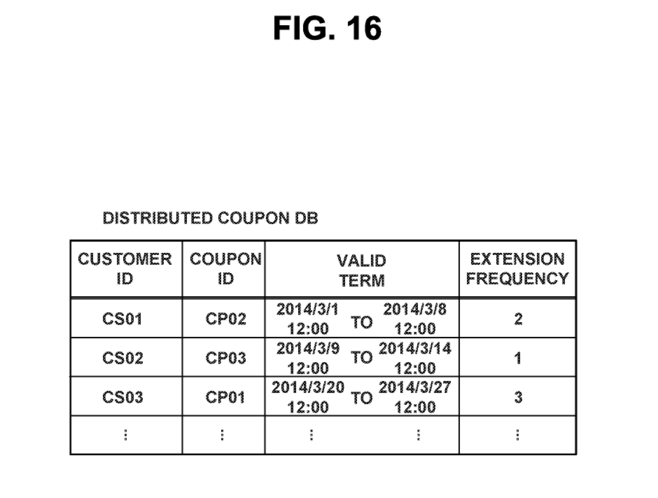

FIG. 16 shows one example of data stored in the distributed coupon DB 122 according to the fourth exemplary embodiment. The distributed coupon DB 122 according to the fourth exemplary embodiment shown in FIG. 16, in comparison to the distributed coupon DB 122 according to the first exemplary embodiment shown in FIG. 5, further stores the extension frequency for the coupon valid term, for each customer.

In the extension period determining process of the first exemplary embodiment shown in FIG. 10, the extension unit 102 determines the extension period by comparing the distributed effective number N to threshold values N1 and N2. In place of this, in the extension period determining process the extension unit 102 according to the fourth exemplary embodiment determines the extension period for example by comparing the sum of the distributed effective number and extension frequency with a threshold value. Then the extension unit 102 references the distributed coupon DB 122 at the time of extension and updates the extension frequency and the extended valid term.

As described above, the coupon management apparatus 100 according to the fourth exemplary embodiment determines the extension period based on the frequency with which valid terms set on coupons distributed to the customer have been extended in the past, in addition to the total number of coupons which were distributed to other customers and for which valid terms that have not elapsed were set. Through this, it is possible to reflect the extension frequency in the extension period. In addition, it is possible to promote prompt purchases by the customer by shortening the extension period the larger the extension frequency.

### Fifth Exemplary Embodiment

In the first through fourth exemplary embodiments described above, the distribution unit 101 distributes coupons by determining valid terms based on the absolute valid term and initial valid period preset in the coupon management DB 121.

However, the method of determining the valid term of coupons at the time of distribution is not limited to this. In a fifth exemplary embodiment, an example is described in which the valid term is set based on the total number of coupons where were distributed to other customers and for which valid terms have not yet elapsed.

Below, one example of a method of determining valid terms by the distribution unit 101 according to the fifth exemplary embodiment is described. In the explanation below, the distribution unit 101 sets the valid terms of coupons to be distributed from now so that the valid period becomes shorter the larger the total number of coupons with set valid terms that have not yet elapsed that were distributed to other customers (distributed effective number) is.

For example, the distribution unit 101 determines the valid period as E1 (for example, one month) when the distributed effective number N is less than a first valid period threshold value M1 (for example, 100). In addition, the distribution unit 101 determines the valid period as E2 (where E2<E1; for example, one week) when the distributed effective number N is at least as great as M1 but less than a second valid period threshold value M2 (where M2>M1; for example, 500). In addition, the distribution unit 101 determines the valid period as E3 (where E3<E2; for example, one day) when the distributed effective number N is at least as great as M2. M1, M2, and E1-E3 may be set in advance by the shop or the manager of the online shopping site, or may be set in accordance with the applicable total number of coupons or the absolute valid term. In addition, in the above-described example, the valid period was determined using the two threshold values M1 and M2, but the number of threshold values is not limited to this.

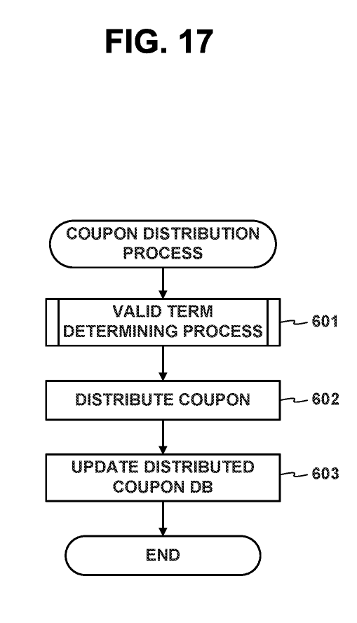

Next, a coupon distribution process executed by the coupon management apparatus 100 according to the fifth exemplary embodiment is described. FIG. 17 shows one example of a flowchart for a coupon distribution process according to the fifth exemplary embodiment. The coupon distribution process shown in FIG. 17 starts for example when input ordering the distribution of coupons is received via the communicator 150 or the operator 160 from the shop or the manager of the online shopping site. This process is executed for example by the CPU of the controller 110 reading a program stored in the ROM 120.

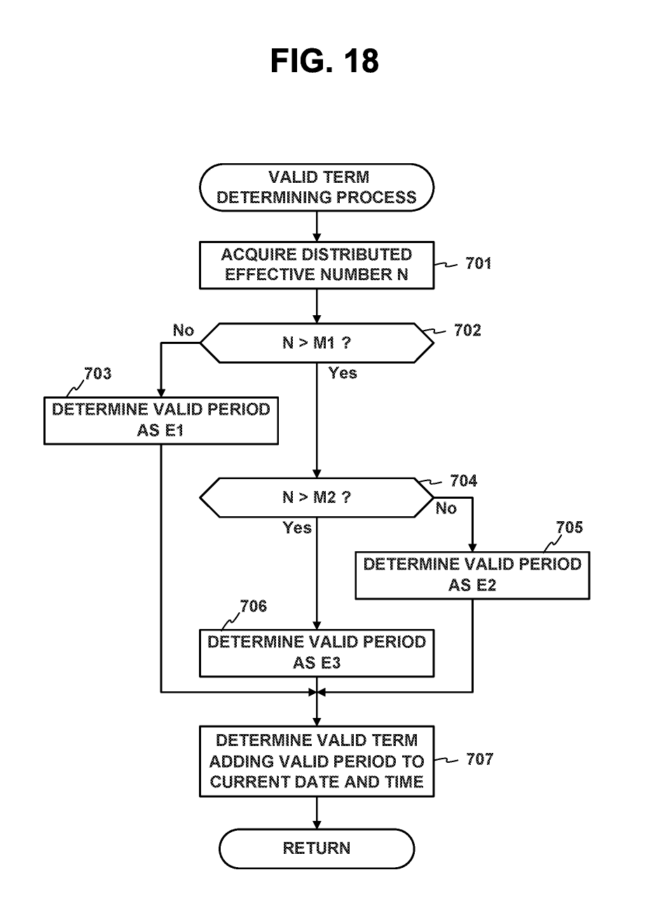

First, the distribution unit 101 executes a valid term determining process shown in FIG. 18 (step S601).

FIG. 18 shows one example of a flowchart of the valid term determining process. As shown in FIG. 18, when the valid term determining process is started, the distribution unit 101 references the distributed coupon DB 122 and acquires the total number (distributed effective number) N of coupons for which the valid term has not yet elapsed, out of the coupons already distributed, in the coupons to be distributed (step S701).

Next, the distribution unit 101 determines whether or not the distributed effective number N acquired in step S701 is larger than a first valid period threshold value M1 (step S702).

When it is determined that the distributed effective number N is not larger than the first threshold value M1 (step S702: No), the distribution unit 101 determines the valid period as E1 (step S703). Then, the process advances to step S707.

When it is determined that the distributed effective number N is larger than the first threshold value M1 (step S702: Yes), the distribution unit 101 determines whether or not the distributed effective number N is larger than a second valid period threshold value M2 (step S704).

When it is determined that the distributed effective number N is not larger than the second threshold value M2 (step S704: No), the distribution unit 101 determines the valid period as E2 (step S705). Then, the process advances to step S707.

When it is determined that the distributed effective number N is larger than the second threshold value M2 (step S704: Yes), the distribution unit 101 determines the valid period as E3 (step S706).

Next, the distribution unit 101 determines a new valid term by adding the determined valid period to the current date and time (step S707).

For example, when input ordering distribution of a coupon with coupon ID “CP03” is received via the operator 160 from the manager of the online shopping site, the distribution unit 101 references the distributed coupon DB 122 and acquires as the distributed effective number N the total number of coupons having coupon ID “CP03” for which the valid term has not elapsed. Then, if it is determined that the distributed effective number N is such that M1<N<M2, the distribution unit 101 determines the valid period as E2 (for example, one week) as. Then, when the current date and time is “2014/3/10 12:00”, the distribution unit determines the valid period as “2014/3/1012:00-2014/3/17 12:00” from the current date and time until the set valid period elapses.

Then, returning to the flowchart in FIG. 17, the distribution unit 101 distributes to the customer a coupon set with the valid term determined in step S601 (step S602).

Specifically, the distribution unit 101 references the coupon management DB 121 and distributes coupons for which the valid term determined in step S601 is set to customers satisfying the coupon distribution conditions, with the applicable total number as the upper limit.

For the coupons distributed in step S602, the distribution unit 101 updates the distributed coupon DB 122 the same as in step S102 of the coupon distribution process according to the first exemplary embodiment shown in FIG. 8 (step S603).

Then, the coupon management apparatus 100 ends the coupon distribution process.

As explained above, the coupon management apparatus 100 according to the fifth exemplary embodiment sets the valid term of coupon to be distributed based on the total number of coupons which were distributed to other customers and for which valid terms that have not yet elapsed were set. In addition, the coupon management apparatus 100 can promote prompt use of coupons by customers to which the coupons are distributed by making the valid period set for the coupon to be distributed shorter the larger the distributed effective number is.

### Sixth Exemplary Embodiment

In the above-described fifth exemplary embodiment, an example was described in which the distribution unit 101 determines the valid term based on the total number of coupons with set valid terms that have not yet elapsed that were distributed to other customers, but the method of determining valid terms for coupons to be distributed is not limited to this. In a sixth exemplary embodiment, an example is described wherein the valid term of coupon to be distributed is determined based on the applicable total number set in advance for coupon distribution, and the number of coupons applied.

In the sixth exemplary embodiment, the applicable total value of the coupon is set in advance by the shop or the manager of the online shopping site that issues the coupon. The applicable total value is the total value of discounts when all coupons are applied. For example, the applicable total value is determined as the budget for coupon distribution by the shop or the manager of the online shopping site that issues the coupon.

The distribution unit 101 determines the applicable total number from the applicable total value and the discount value, for example. Furthermore, the distribution unit 101 subtracts the applied number and the distributed effective number from the applicable total number to determine a distributable number. The distribution unit 101 shortens the valid period of the coupon to be distributed the smaller the distributable number is.

For example, when the distributable number K is less than the third valid period threshold value M3 (for example, 100), the distribution unit 101 determines the valid period as F1 (for example, 1 day). In addition, when the distributable number K is at least as great as M3 and less than a fourth valid period threshold value M4 (where M4>M3; for example 500), the distribution unit 101 determines the valid period as F2 (where F2>F1; for example, 1 week). In addition, when the distributable number K is at least as great as M4, the distribution unit 101 determines the valid period as F3 (where F3>F2: for example, 1 month). M3, M4 and F1-F3 may be set in advance by the shop or the manager of the online shopping site, or may be set in accordance with the applicable total number of the coupon or the absolute valid term. In addition, in the above-described example, the valid period was determined using two threshold values M3 and M4, but the number of threshold values is not limited to this.

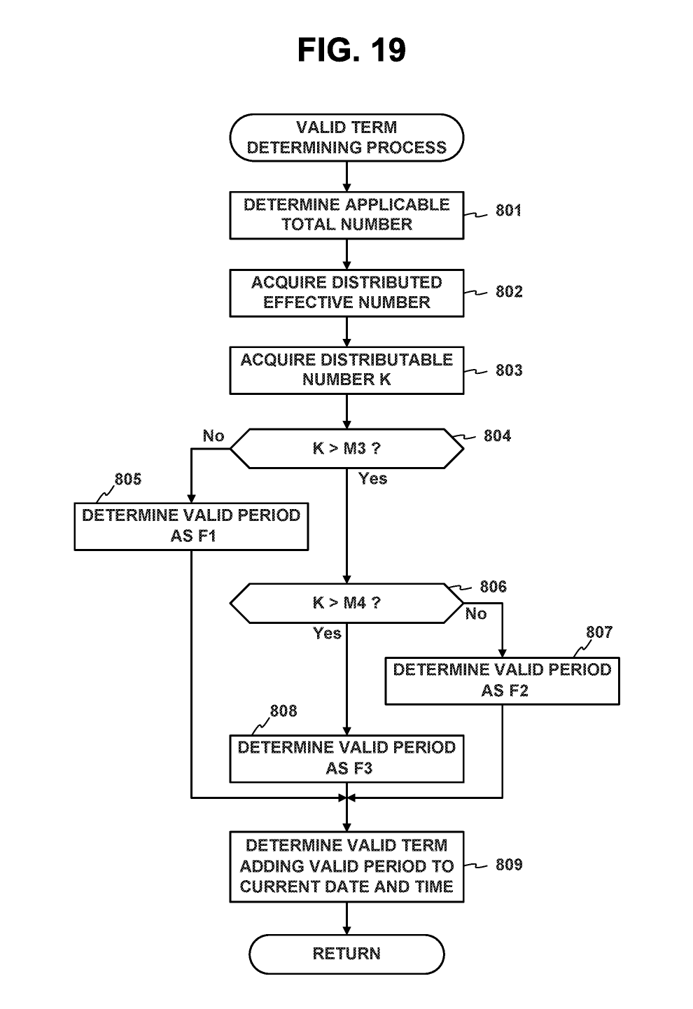

Next, a valid term determining process executed by the coupon management apparatus 100 according to the sixth exemplary embodiment is described. FIG. 19 shows one example of a flowchart for the valid term determining process according to the sixth exemplary embodiment. The valid term determining process shown in FIG. 19 is started when the coupon distribution process is executed, for example the same as the coupon distribution process according to the fifth exemplary embodiment shown in FIG. 17.

First, the distribution unit 101 references the coupon management DB 121 and determines the applicable total number from the discount value and the applicable total value of coupons to be distributed (step S801).

Next, the distribution unit 101 references the distributed coupon DB 122 and acquires the total number of coupons for which the valid terms have not yet elapsed (distributed effective number) from the coupons already distributed, in the coupons to be distributed (step S802).

Next, the distribution unit 101 acquires the distributable number K by subtracting the applied number of coupons to be distributed stored in the coupon management DB 121 and the distributed effective number acquired in step S802 from the applicable total number set in step S801 (step S803).

Next, the distribution unit 101 determines whether or not the distributable number K acquired in step S803 is larger than the third valid period threshold value M3 (step S804).

When it is determined that the distributable number K is not larger than M3 (step S804: No), the distribution unit 101 determines the valid period as F1 (step S805). Then, the process advances to step S809.

When it is determined that the distributable number K is larger than M3 (step S804; Yes), the distribution unit 101 determines whether or not the distributable number K is larger than the fourth valid period threshold value M4 (step S806).

When it is determined that the distributable number K is not larger than M4 (step S806: No), the distribution unit 101 determines the valid period as F2 (step S807). Then, the process advances to step S809.

When it is determined that the distributable number K is larger than M4 (step S806: Yes), the distribution unit 101 determines the valid period as F3 (step S808). Then, the process advances to step S809.

Then, the distribution unit 101 determines a new valid term by adding the determined valid period to the current date and time (step S809).

After the valid term determining period shown in FIG. 19 ends, the distribution unit 101 executes the process the same as steps S602-S603 of the coupon distribution process according to the fifth exemplary embodiment shown in FIG. 17.

As described above, the coupon management apparatus 100 according to the sixth exemplary embodiment determines the applicable total number based on the applicable total value of coupons to be distributed, and determines the distributable number by subtracting the applied number and the distributed effective number from the applicable total number. Accordingly, the shop or the manager of the online shopping site that issues the coupons can use coupons without exceeding the budget for coupon distribution, or leaving unused.

The exemplary embodiments of the present disclosure were described above, but the present disclosure is not limited by the exemplary embodiments.

For example, in the above-described exemplary embodiments, the discount value of the product was set for the coupons, but the type of coupon is not limited to this. For example, it would be fine for a product discount percentage to be set for a coupon.

In addition, in the above-described exemplary embodiments, the coupon management apparatus 100 determines the extension period or the valid period by accomplishing comparison with threshold values with the number of coupons as the standard. However, the coupon management apparatus 100 may set the extension period or the valid period by accomplishing comparison with threshold values using the coupon monetary value as a standard in place of the number of coupons.

In addition, in the above-described first to fourth exemplary embodiments, methods of determining the extension period were described, and in the fifth and sixth exemplary embodiments, methods of determining the valid period were described, but the methods of determining the extension period in the first through fourth exemplary embodiments may also be used to determine the valid period, and in addition, the methods of determining the valid period in the fifth and sixth exemplary embodiments may be used to determine the extension period. In addition, the methods of determining the extension period in the first through fourth exemplary embodiments and the methods of determining the valid period in the fifth and sixth exemplary embodiments may be combined with each other.

In the above-described exemplary embodiments, the program executed by the coupon management apparatus 100 may be stored and distributed on a computer-readable non-transitory recording medium such as a flexible disk, CD-ROM (Compact Disk Read-Only Memory), DVD (Digital Versatile Disk), MO (Magneto-Optical Disk) and/or the like. Furthermore, the coupon management apparatus 100 for executing the above-described processes can comprise by the program being installed on an information processing apparatus such as a personal computer and/or the like.

In addition, the program may be stored on a disk device and/or the like having a prescribed server apparatus on a communication network such as the Internet and/or the like. Furthermore, it would be fine for the program to be overlaid on carrier waves and downloaded, for example.

In addition, when the above-described functions are realized by sharing with the OS (Operating System) or realized through cooperation between the OS and applications, it would be fine for the program other than the part realizing the functions of the OS to be stored and distributed on a recording medium or downloaded.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### INDUSTRIAL APPLICABILITY

The present disclosure is applicable to electronic transactions using a network such as the Internet and/or the like.

### REFERENCE SIGNS LIST

1 Coupon management system
100 Coupon management apparatus
101 Distribution unit
102 Extension unit
103 Reply unit
110 Controller
120 ROM
121 Coupon management database
122 Distributed coupon database
123 Customer database
130 RAM
140 Display device
150 Communicator
160 Operator
170 Bus
200 Sales apparatus
300 Shop terminal
400 Customer terminal
500 Network
600 Product page
601 Product image
602 Product information
603 Coupon information
604 Coupon image
605 Inquiry button
606 Valid term

1. A coupon management apparatus comprising:
a distribution unit for distributing to a customer a coupon for which a valid term has been set;
an extension unit for, upon receipt of an inquiry about the valid term set for the coupon from the customer to whom the coupon was distributed, acquiring the valid term set for the coupon and, if the acquired valid term has elapsed, extending the valid term set for the coupon; and
a reply unit for replying to the inquiry with the valid term set for the coupon,
wherein the distribution unit estimates a remaining number or remaining value of distributable coupons so that a sum of a total number or total value of coupons set for which the valid terms have not yet elapsed, out of the coupons distributed to other customers that are not yet applied, and the total number or total value of coupons already applied is not greater than an applicable total number or applicable total value of coupons to be distributed, and determines the valid term set for the coupon to be distributed based on the remaining number or remaining value, and
wherein the extension unit determines the period of the extension based on at least the total number or total value of coupons which valid terms that have not yet elapsed were set out of the coupons distributed to other customers that are not yet applied.

2. The coupon management apparatus according to claim 1, wherein the extension unit determines the period of the extension to be shorter the larger the total number or total value is.

3. The coupon management apparatus according to claim 1, wherein the extension unit resets a coupon-applied discount value or discount percentage at the time of the extension.

4. The coupon management apparatus according to claim 3, wherein the reset discount value or discount percentage is determined based on an attribute of the customer.

5. The coupon management apparatus according to claim 1, wherein the extension unit further determines the period of the extension based on the total number or total value of coupons already applied.

6. The coupon management apparatus according to claim 1, wherein the extension unit further determines the period of the extension based on the frequency with which the valid term set for the coupon distributed to the customer has been extended in the past.

7. (canceled)

8. (canceled)

9. A coupon management method executed by a coupon management apparatus comprising a distribution unit, an extension unit and a reply unit, the method including:
a distribution step in which the distribution unit distributes to a customer a coupon for which a valid term has been set;
an extension step in which, upon receipt of an inquiry about the valid term set for the coupon from the customer to whom the coupon was distributed, the extension unit acquires the valid term set for the coupon and, if the acquired valid term has elapsed, extends the valid term set for the coupon; and
a reply step in which the reply unit replies to the inquiry with the valid term set for the coupon,
wherein in the distribution step, the distribution unit estimates a remaining number or remaining value of distributable coupons so that a sum of a total number or total value of coupons set for which the valid terms have not yet elapsed, out of the coupons distributed to other customers that are not yet applied, and the total number or total value of coupons already applied is not greater than an applicable total number or applicable total value of coupons to be distributed, and determines the valid term set for the coupon to be distributed based on the remaining number or remaining value, and
wherein in the extension step, the extension unit determines the period of the extension based on at least the total number or total value of coupons which valid terms that have not yet elapsed were set out of the coupons distributed to other customers that are not yet applied.

10. (canceled)

11. A computer-readable non-transitory recording medium on which is recorded a program that causes a computer to function as:
a distribution unit for distributing to a customer a coupon for which a valid term has been set;
an extension unit for, upon receipt of an inquiry about the valid term set for the coupon from the customer to whom the coupon was distributed, acquiring the valid term set for the coupon and, if the acquired valid term has elapsed, extending the valid term set for the coupon; and
a reply unit for replying to the inquiry with the valid term set for the coupon,
wherein the distribution unit estimates a remaining number or remaining value of distributable coupons so that a sum of a total number or total value of coupons set for which the valid terms have not yet elapsed, out of the coupons distributed to other customers that are not yet applied, and the total number or total value of coupons already applied is not greater than an applicable total number or applicable total value of coupons to be distributed, and determines the valid term set for the coupon to be distributed based on the remaining number or remaining value, and
wherein the extension unit determines the period of the extension based on at least the total number or total value of coupons which valid terms that have not yet elapsed were set out of the coupons distributed to other customers that are not yet applied.
